(19) United States
(12) Patent Application Publication
(10) Pub. No.: US 2011/0105104 A9
(43) Pub. Date: May 5, 2011

(54) WIRELESS COMMUNICATIONS NETWORK AND METHOD OF DETERMINING ADJACENCY OF SITES IN A WIRELESS COMMUNICATIONS NETWORK

(75) Inventors: Steen Petersen, Frederiksberg (DK); Svend Frandsen, Praestoe (DK)

(73) Assignee: MOTOROLA, INC., Schaumburg, IL (US)

(21) Appl. No.: 11/610,123

(22) Filed: Dec. 13, 2006

Related U.S. Application Data
(63) Continuation of application No. PCT/US05/19828, filed on Jun. 6, 2005.

(30) Foreign Application Priority Data
Jun. 25, 2004 (GB) 0414225.3

(51) Int. Cl. H04Q 7/20

(52) U.S. Cl. 455/422.1

(57) ABSTRACT

A wireless communications network (100) comprising a plurality of sites, each of which is served by a base transceiver station (102, 106, 110, 114, 118, 122, 126, 130). The base transceiver stations (102, 106, 110, 114, 118, 122, 126, 130) are connected with other elements of infrastructure (134-142) and at least one of said base transceiver stations (102) comprises means (104) for determining its geographical location. Said base transceiver station (102) is adapted to be moved from a first geographical location to a second geographical location. A first database (146) is configured to store location data of said base transceiver stations (102, 106, 110, 114, 118, 122, 126, 130). The network (100) further comprises a controller (144) configured to receive location data from the at least one base transceiver station (102) and from the first database (146) and to determine adjacency of sites.

### FIELD OF THE INVENTION

The present invention relates to a wireless communication network, in general, and in particular, to a method of determining adjacency of sites in a wireless communications network.

### BACKGROUND OF THE INVENTION

In a cellular communication system (like for example the Global System for Mobile communication (GSM) and TETRA (TErrestrial Trunked RAdio)), a geographical region is divided into a number of cells each of which is served by a base transceiver station. One base transceiver station, also termed as Base Transceiver Station (BTS) with a switching infrastructure is referred as a node of the network. The switching infrastructure supporting BTS may be shared with other BTSs. The system infrastructure in a TETRA system is generally referred to as a switching and management infrastructure (SwMI), which substantially contains all of the communication elements apart from the Mobile Stations (MSs). This includes base transceiver stations (BTSs) connected to a conventional public-switched telephone network (PSTN) through base station controllers (BSCs) and mobile switching centres (MSCs). In geographical terms reference to a node is a reference to an area served by one BTS, and in network terms reference to a node is a reference to the infrastructure equipment required to support one or more BTSs. A remote unit referred also as subscriber or mobile station (MS) or communication unit is served via a radio communication link by the BTS of the cell within which the remote unit is operating.

One of the basic advantages of the cellular communications systems is that subscriber may move from one geographical location to another one while receiving services from the network. To provide seamless service there are regions of overlapping coverage between base transceiver stations. As the subscriber moves from area served by a first base transceiver station towards area served by a second base transceiver station it enters the region of overlapping coverage. Within the region of overlapping coverage the subscriber changes the serving base transceiver station. This is known as cell reselection or handover.

The communication link from a BTS to a subscriber is generally referred to as a downlink communication channel. Conversely, the communication link from a subscriber to a BTS is generally referred to as an up-link communication channel.

To enable communication between two handsets operating in two different cells a fixed network interconnects the base transceiver stations. The fixed network is operable to route data between any two base transceiver stations and this way allows for communication between these two remote handsets. In addition, the fixed network may comprise gateway functions for interconnecting to external networks such as the Public Switched Telephone Network (PSTN). This allows subscribers to communicate with landline telephones and other communication terminals connected by a landline. Additionally the fixed network is adapted to perform functions required for managing a conventional cellular communication network including routing data, admission control, resource allocation, subscriber billing, mobile station authentication etc.

The TETRA communications system may be used as a public cellular communication system. However a principal application of TETRA communication systems is for use by are organizations or groups such as emergency services. Special functions and services implemented in the TETRA system make this system especially suitable for services like police, emergency, fire rescue or others. One of such features provided by TETRA system, which is especially useful for the emergency services is controlling group calls as well as managing the membership of these groups. Other features and services provided by TETRA include, push-to-talk channel allocation, broadcast calls etc. In addition to trunked mode operation wherein remote units communicate via a base transceiver station, TETRA provides for the possibility of communication directly between remote units without participation of the infrastructure. This is known as Direct Mode Operation (DMO).

A deployable or ad-hoc network may be considered as one in which the topology of the network and number of nodes which together offer service to mobile users changes from time to time. The connections between these nodes also change in number and topography from time to time, either together with or independently of changes in the nodes. Nodes may be added or may be taken away.

In such deployable networks it is necessary for the infrastructure to know the adjacencies of the base transceiver station sites in order to aid subscriber handover when roaming between base transceiver stations. In networks known in the art the adjacency information is configured manually based on the knowledge of topology of the radio system. However if the base transceiver stations are moved from one location to another, e.g. in military communications network, then the update of adjacencies is complicated and time consuming.

A need therefore exists for a method of controlling and identifying location information of base transceiver stations in a communications network, particularly when the network is required to be operational irrespective of reconfiguration processes.

### SUMMARY OF THE INVENTION

According to a first aspect of the present invention there is provided a wireless communications network as claimed in claim 1.

According to a second aspect of the present invention there is provided a method of determining adjacency of sites in a wireless communications network as claimed in claim 16.

The present invention beneficially allows for:
re-configuration of the network's control channels after moving at least one of the Base Stations between two different locations;
quick and automatic configuration of newly deployed network;
automatic re-configuration of the network's adjacent channel configuration for broadcast on the control channels after moving at least one of the Base Transceiver Stations between two different locations;
automatic prediction of interference between newly deployed and existing Base Transceiver Stations and mechanism for changing the transmit/receive frequencies of the Base Transceiver Stations accordingly.

### BRIEF DESCRIPTION OF THE DRAWINGS

The present invention will be understood and appreciated more fully from the following detailed description taken in conjunction with the drawings in which:

FIG. 1 is a diagram illustrating a wireless communications network in one embodiment of the present invention;

FIG. 2 is a diagram illustrating portion of a wireless communications network in one embodiment of the present invention;

FIG. 3 is a diagram illustrating portion of a wireless communications network in one embodiment of the present invention;

FIG. 4 is a flow chart illustrating a method of determining adjacency of sites in a wireless communications network in one embodiment of the present invention.

### DESCRIPTION OF AN EMBODIMENT OF THE INVENTION

The following description focuses on an embodiment of the invention applicable to a TETRA cellular communication system. However, it will be appreciated that the invention is not limited to this application but may be applied to many other communication systems (e.g. APCO Project 25 or GSM and other digital and analogue communication systems).

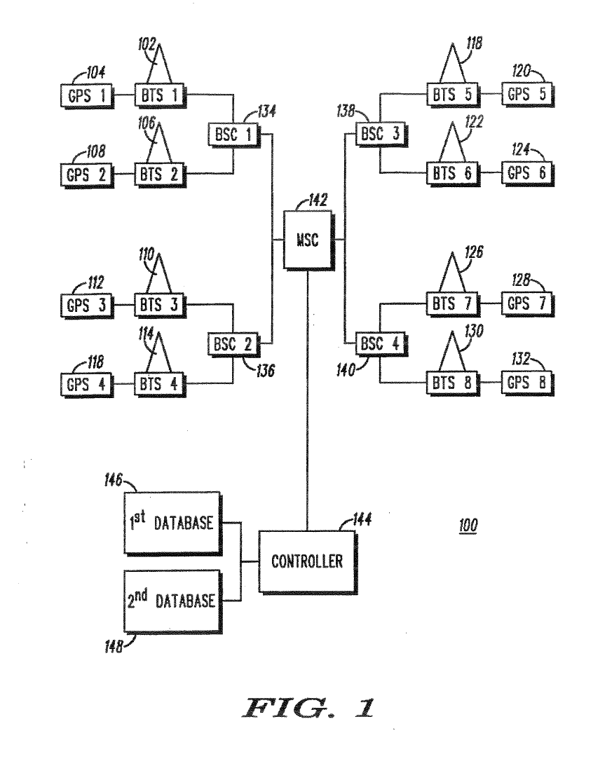

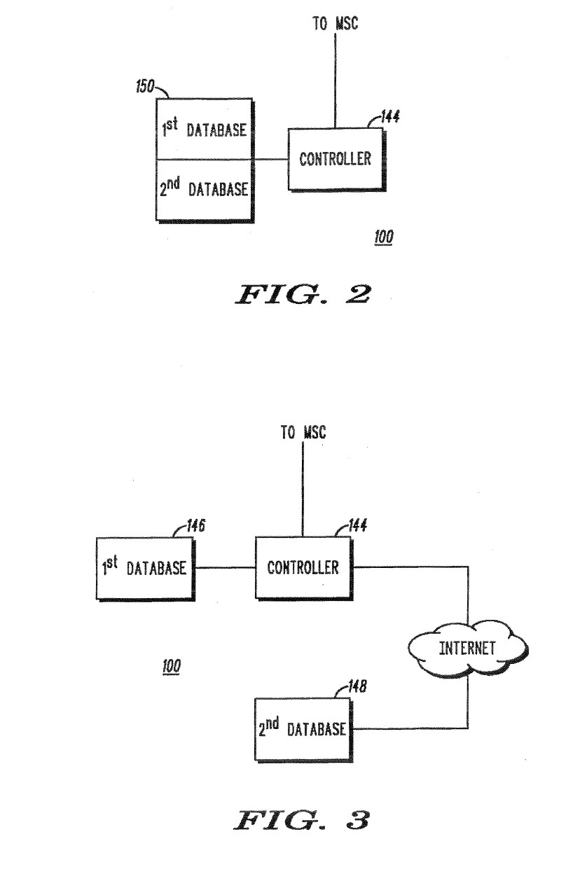

With reference to FIG. 1 through FIG. 3 a wireless communications network 100 (e.g. deployable or ad-hoc communications network) in one embodiment of the present invention is shown. For the sake of clarity the diagram illustrating embodiment of the network 100 depicted on FIG. 1 is simplified. The network 100 comprises a plurality of sites, each of which is served by a base transceiver station 102, 106, 110, 114, 118, 122, 126, 130. These base transceiver stations 102, 106, 110, 114, 118, 122, 126, 130 are connected with other elements of infrastructure like Base Station Controllers 134-140 or Mobile Switching Centres 142. All elements of infrastructure are connected by means of so called backbone network. Depending on particular embodiment the backbone network can be a fixed wireline network or network based on radio links or a combination of wireline and radio links.

In one embodiment at least one of said base transceiver stations 102, 106, 110, 114, 118, 122, 126, 130 comprises means 104 for determining its geographical location. However in alternative embodiments every base transceiver station in the network 100 has said means for determining its geographical location. In one embodiment, the means for determining geographical location is a Global Positioning System (GPS) unit 104, 108, 112, 116, 120, 124, 128, 132. The primary function of the GPS unit in the base transceiver station is providing synchronization with other elements of the network. For said synchronization a very accurate time signal received by the GPS unit is used.

In deployable or ad-hoc networks said base transceiver stations 102, 106, 110, 114, 118, 122, 126, 130 are adapted to be moved from one geographical location to other geographical location. In the simplest case only one base transceiver station 102 is moved from a first location to a second location. Moving base transceiver stations or deploying network in new locations is especially useful in communication networks used by special services, like police, fire fighters, etc. It may happen that they will need communication network in a place where it was not necessary before (e.g. in places of big events when a huge group of people gathers in remote place for limited period of time).

The network 100 further comprises a first database 146 configured to store location data of said base transceiver stations 102, 106, 110, 114, 118, 122, 126, 130. The location data consist of coordinates of the base transceiver stations. Another element of the network 100 is a controller 144 which is configured to receive location data from the at least one base transceiver station 102 and from the first database 146 and to determine adjacency of sites based on the received data. Determining how sites are adjacent to each other is necessary to configure control channels and to eliminate interference and correct coverage of area of the site. To meet this objective said controller 144 is adapted to update 213 the infrastructure with determined adjacency data and said infrastructure is adapted to adjust its settings in response to said adjacency data.

In one embodiment said infrastructure configures control channels to transmit the adjacency data to Mobile Stations. The Mobile Stations need these data to know which frequencies should search on for possible BTS to roam to. The adjacency information is also used for changing frequencies of signals transmitted by the BTSs (on RF channels, i.e. control channels and traffic channels) in a way that interference between signals transmitted by the BTSs is avoided.

In the simplest case the adjacency is determined only on the basis of location data of the base transceiver stations 102, 106, 110, 114, 118, 122, 126, 130. However in alternative embodiments topography of the area is also considered. In these alternative embodiments the controller 144 is configured to obtain topographical data from a second database 148.

There are many possible embodiments that provide access to the second database 148. The second database 148 may be:

1) a separate unit of the network's 100 infrastructure and accessed by the controller 144 via the backbone network;

2) integrated with the first database 146;

3) incorporated in the controller 144 (separately or integrated with the first database 146);

4) independent and remote from the network 100 and accessed by the controller 144 via internet or other network.

The network 100 is configured in a way that if the second database 148 is not available or does not contain topographical data of required area the controller 144 determines adjacency based only on the location data provided by the base transceiver stations 102, 106, 110, 114, 118, 122, 126, 130 to the first database 146.

In one embodiment the controller 144 is a computing device operably connected to a Base Station Controller 134-140. Alternatively it can be connected to a Mobile Switching Centre 142 or be implemented as a stand-alone device operably connected to the backbone network (network that interconnects the communication network's infrastructure).

In yet another embodiment the controller 144 is a computing device integrated with a Base Station Controller 130-140 or a Mobile Switching Centre 142.

If the location of the base transceiver station has changed significantly since the last time the location was determined, the location is transmitted to the controller 144 where the locations of all base transceiver stations are stored and/or processed.

The distance between base transceiver stations' locations can then be determined by the controller 144 based on simple calculations on the longitude/latitude stored for each base transceiver station.

The determination, of which base transceiver stations are adjacent to each other, can then be made based on the distance between the base transceiver stations. This could be any base transceiver station closer than a given (configurable) distance (for example less than 10 km apart) or a specific number of the closest base transceiver stations (for example the three closest).

In a trunking radio system (like a TETRA system) every base transceiver station broadcasts information about adjacent base transceiver stations. This is done for mobility management in order for the individual Mobile Stations to know which frequencies to search on for possible base transceiver stations to roam to. The actual roaming is done following the air interface protocol and trunking standard. In order for the individual base transceiver stations to know which adjacent base transceiver stations to broadcast information about, the base transceiver stations needs to know the adjacency information. This controller 144 informs all the base transceiver stations about their current adjacencies. In an alternative implementation the base transceiver stations are configured with information about the possible adjacencies and with a keep-alive protocol (like polling) that determines the current operation of the possible adjacent base transceiver stations.

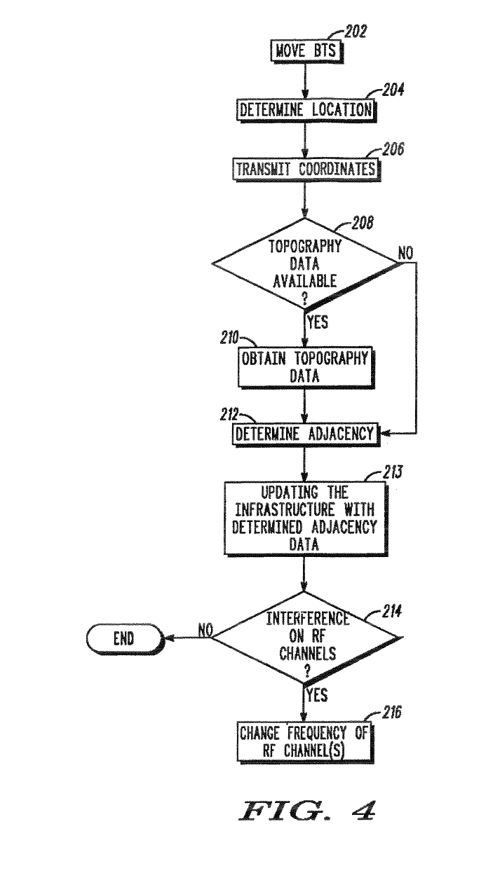

With reference to FIG. 4 a method of determining adjacency of sites in a wireless communications network 100 (e.g. deployable or ad-hoc communications network) in one embodiment of the present invention is shown. The method comprises the step of deploying a first base transceiver station in a second geographical location. This deployment may be a result of building a new network or reconfiguration of the existing network 100 where said reconfiguration involves moving at least one, 102, of the base transceiver stations from a first geographical location to a second geographical location. When the base transceiver station 102 is deployed in a second location said GPS unit 104 determines its geographical coordinates using GPS data. In alternative embodiment said coordinates are determined, based on GPS data, in the base transceiver station 102.

In the next step said coordinates are transmitted 206 from said first base transceiver station 102 to a first database 146, wherein said first database 146 is used for storing location data of base transceiver stations of said network 100.

Next, in said controller 144, adjacency of sites is determined 212 using data from said first database 146. In one embodiment in addition to the location coordinates from the first database 146 said controller 144 obtains topographical data from a second database 148.

When the adjacency is determined 212 said controller 144 updates 213 the infrastructure with said determined 212 adjacency data. It is important that the infrastructure adjusts its settings in response to said adjacency data. In one embodiment, in the step of adjustment the infrastructure, to avoid interference, changes frequency 214, 216 of RF channels provided in said sites, in response to said adjacency data.

In summary the invention provides a communication network having base transceiver stations with means for determining geographical coordinates of the base transceiver station and for determining adjacency of sites on the basis of said coordinates and in consequence for configuration of the control channels in the sites of the network 100 in such a way that information on adjacent sites is transmitted on the control channel. This information is used by individual Mobile Stations in order to know which frequencies to search on for possible BTS to roam to. The adjacency information is also used for changing frequencies of signals transmitted by the BTSs in a way that interference between signals transmitted by the BTSs is avoided.

1. A wireless communications network (100) comprising:
a plurality of sites, each of which is served by a base transceiver station (102, 106, 110, 114, 118, 122, 126, 130), wherein said base transceiver stations (102, 106, 110, 114, 118, 122, 126, 130) are connected with other elements of infrastructure (134-142) and at least one of said base transceiver stations (102) comprises means (104) for determining its geographical location, wherein said base transceiver station (102) is adapted to be moved from a first geographical location to a second geographical location;
a first database (146) configured to store location data of said base transceiver stations (102, 106, 110, 114, 118, 122, 126, 130);
a controller (144) configured to receive location data from the at least one base transceiver station (102) and from the first database (146) and to determine adjacency of sites.

2. The network (100) according to claim 1,
wherein said controller (144) is configured to obtain topographical data from a second database (148);
wherein said controller comprises said first database and said second database integrated (150) into one unit of said controller (144); and
wherein said controller (144) is a computing device operably connected or integrated a) to a Base Station Controller (134-140), b) to a Mobile Switching Centre (142) or c) to a network that interconnects the network's infrastructure as a stand-alone device.

3. The network (100) according to claim 1, wherein said means (104) for determining geographical location is a GPS unit.

4. The network (100) according to claim 1, wherein said controller (144) is adapted to update the infrastructure with determined adjacency data.

5. The network (100) according to claim 2 wherein said infrastructure, in response to said adjacency data is adapted to at least one of a) to adjust its settings, b) to configure control channels, provided in said sites in such a way that information on adjacent sites is transmitted on the control channel, and c) to change frequency of RF channels of said base transceiver stations (102, 106, 110, 114, 118, 122, 126, 130).

6. A method of determining adjacency of sites in a wireless communications network (100) comprising the steps of:
deploying a first base transceiver station in a second geographical location;
determining coordinates (204) of said second geographical location;
transmitting (206) said coordinates from said first base transceiver station (102) to a first database (146) for storing location data of base transceiver stations of said network;
in said controller (144), determining adjacency (212) of sites using data from said first database.

7. The method according to claim 6, wherein said controller (144) updates (213) the infrastructure with determined (212) adjacency data.

8. The method according to claim 7, wherein said infrastructure in response to said adjacency data performs at least one of a) adjusts its settings, b) configures control channels (216) provided in said sites in such a way that information on adjacent sites is transmitted on the control channel, and c) changes frequency (214, 216) of RF channels of said Base Transceiver Stations.

9. The method according to claim 6, wherein said controller (144) obtains topographical data from a second database (148).

10. The method according to claim 6, wherein said first base transceiver station is deployed in the second geographical location after moving (202) from a first geographical location.
